(19) United States
(12) Patent Application Publication
(10) Pub. No.: US 2025/0320874 A1
(43) Pub. Date: Oct. 16, 2025

(54) MOTOR IDLING DETECTION DEVICE, MOTOR CONTROL DEVICE, METHOD FOR DETECTING MOTOR IDLING AND TANGIBLE COMPUTER READABLE STORAGE MEDIUM

(71) Applicant: DENSO CORPORATION, Kariya-city (JP)

(72) Inventors: TAKUYA KOIZUMI, Kariya-city (JP); AKIHIRO KONNO, Kariya-city (JP)

(21) Appl. No.: 19/048,644

(22) Filed: Feb. 7, 2025

(30) Foreign Application Priority Data
Apr. 12, 2024 (JP) 2024-064994

(51) Int. Cl. F04D 15/02; H02P 29/024

(52) U.S. Cl. CPC F04D 15/0254; H02P 29/024

(57) ABSTRACT

A motor idling detection device for detecting idling of a motor that drives a pump that draws in and discharges liquid includes an acquisition unit and an idling determination unit. The acquisition unit acquires a motor voltage applied to the motor. The idling determination unit compares the motor voltage acquired by the acquisition unit with an idling determination threshold value for determining whether the motor is idling, and determines whether the motor is idling or not based on a result of a comparison.

### CROSS REFERENCE TO RELATED APPLICATIONS

This application is based on Japanese Application No. 2024-64994 filed on Apr. 12, 2024, the contents of which are incorporated herein by reference.

### TECHNICAL FIELD

The present disclosure relates to a technique for detecting idling of a motor that drives a pump that draws in and discharges liquid.

### BACKGROUND

For example, a device determines an abnormality in a rotation of an oil pump driven by a motor and stops the oil pump.

### SUMMARY

The present disclosure aims to provide a motor idling detection device, a method for detecting motor idling, and a tangible computer readable medium storing a program that are capable of detecting idling of a motor without using a high-precision current sensor. Furthermore, another object of the present disclosure is to provide a motor control device equipped with such a motor idling detection device.

In order to achieve the above object, a motor idling detection device according to the present disclosure detects idling of a motor that drives a pump that draws in and discharges liquid. The motor idling detection device includes:
an acquisition unit that acquires a motor voltage applied to the motor, and
an idling determination unit that compares the motor voltage acquired by the acquisition unit with an idling determination threshold value for determining whether the motor is idling, and determines whether the motor is idling or not based on a result of a comparison.

### BRIEF DESCRIPTION OF THE DRAWINGS

FIG. 1 is a block diagram showing an overall configuration of a motor control device including a motor idling detection device according to a first embodiment;

FIG. 2 is a flowchart showing a process for determining whether a motor is idling and a procedure to be taken when the motor is idling in the first embodiment;

FIG. 3 is a diagram for explaining a idling determination threshold value in the first embodiment;

FIG. 4 is a flowchart showing details of the idling determination process of the motor in step S140 in the flowchart of FIG. 2;

FIG. 5 is a diagram for explaining a idling determination threshold value in a second embodiment; and

FIG. 6 is a flowchart showing a process for determining whether a motor is idling and a procedure to be taken when the motor is idling in the second embodiment.

### DETAILED DESCRIPTION

In an assumable example, a device determines an abnormality in a rotation of an oil pump driven by a motor and stops the oil pump. This device detects an oil temperature, and calculates a threshold value corresponding to a detected oil temperature by referring to a map of threshold values that are set to higher values as the oil temperature decreases. This device compares the motor's drive current with a calculated threshold value, and when the motor's drive current is smaller than the threshold value, it determines that there is an abnormality in the oil pump's rotation (air suction abnormality) and stops the oil pump.

When a pump that intakes and discharges liquid is driven by a motor, the pump rotates with the lubricant provided by the liquid. Therefore, when the pump is driven by the motor in the absence of liquid, this may adversely affect the performance of the pump, such as its lifespan. For these reasons, the drive current of the motor is compared with a threshold value, and an abnormality in the air intake of the oil pump is determined based on a comparison result.

Here, when the motor drives the oil pump in a state where there is no oil, a load on the motor becomes very small and the motor runs idly. When the motor is idling, the drive current of the motor is very small, and is therefore susceptible to errors and variations. Therefore, the device has a problem in that a highly accurate current sensor is required to accurately measure the drive current of the motor.

The present disclosure has been made in consideration of the above-mentioned problems, and aims to provide a motor idling detection device, a method for detecting motor idling, and a tangible computer readable medium storing a program that are capable of detecting idling of a motor without using a high-precision current sensor. Furthermore, another object of the present disclosure is to provide a motor control device equipped with such a motor idling detection device.

In order to achieve the above object, a motor idling detection device according to the present disclosure detects idling of a motor that drives a pump that draws in and discharges liquid. The motor idling detection device includes:
an acquisition unit that acquires a motor voltage applied to the motor, and
an idling determination unit that compares the motor voltage acquired by the acquisition unit with an idling determination threshold value for determining whether the motor is idling, and determines whether the motor is idling or not based on a result of a comparison.

According to the present disclosure, a method for detecting idling of a motor (50) that drives a pump that draws in and discharges liquid, the method being executed by at least one processor, includes:
obtaining a motor voltage applied to the motor, and
comparing the motor voltage obtained with an idling determination threshold value for determining whether the motor is idling, and determining whether the motor is idling or not based on a result of a comparison.

According to the present disclosure, in a tangible computer readable medium storing a program for causing at least one processor to detect idling of a motor that drives a pump that draws in and discharges liquid, the program includes instructions configured to, when executed by at least one processor, to cause the at least one processor to function as
obtaining a motor voltage applied to the motor, and
comparing the motor voltage obtained with an idling determination threshold value for determining whether the motor is idling, and determining whether the motor is idling or not based on a result of a comparison.

In the above-described motor idling detection device, method for detecting motor idling, and tangible computer readable medium storing a program, the motor voltage applied to the motor is acquired. The acquired motor voltage is compared with the idling determination threshold value for determining whether the motor is idling. Then, depending on the result of the comparison, it is determined whether or not the motor is rotating idly. Therefore, according to the motor idling detection device, method for detecting motor idling, and tangible computer readable medium of the present embodiment, it is possible to detect the idling of the motor without using a highly accurate current sensor.

Here, when the motor is driven to rotate by performing a PWM-control to switching elements constituting the inverter, it is preferable that the motor voltage is calculated and obtained from the duty ratio of the PWM-control and the power supply voltage applied to the inverter. This makes it possible to obtain the motor voltage simply and accurately.

Further, the motor control device according to the present disclosure includes:
the motor idling detection device described above, and
an execution unit that, in response to detecting idling of the motor by the motor idling detection device, executes at least one of the following: storing a detection of idling of the motor, notifying an upper-level control device that indicates a control target value of the motor, and stopping the rotation of the motor.

As a result, according to the motor control device disclosed herein, in addition to the advantageous effects obtained by the motor idling detection device described above, it is possible to achieve the advantageous effect of making it possible to take appropriate measures when the motor is rotating idly.

Technical features described in “Claims” other than the above-mentioned features become apparent from the description of the embodiments and the accompanying drawings.

Hereinafter, preferred embodiments of the present disclosure will be described with reference to the drawings. Note that the same or similar components are denoted by the same reference symbols throughout multiple drawings, and description thereof may be omitted. When only a part of a configuration is described in each embodiment, the configurations of other embodiments previously described can be applied to the other parts of the configuration. In addition to the combination of the configurations explicitly described in the description of each embodiment, the configurations of multiple embodiments may be partially combined even if not explicitly described as long as there is no difficulty in the combination.

### First Embodiment

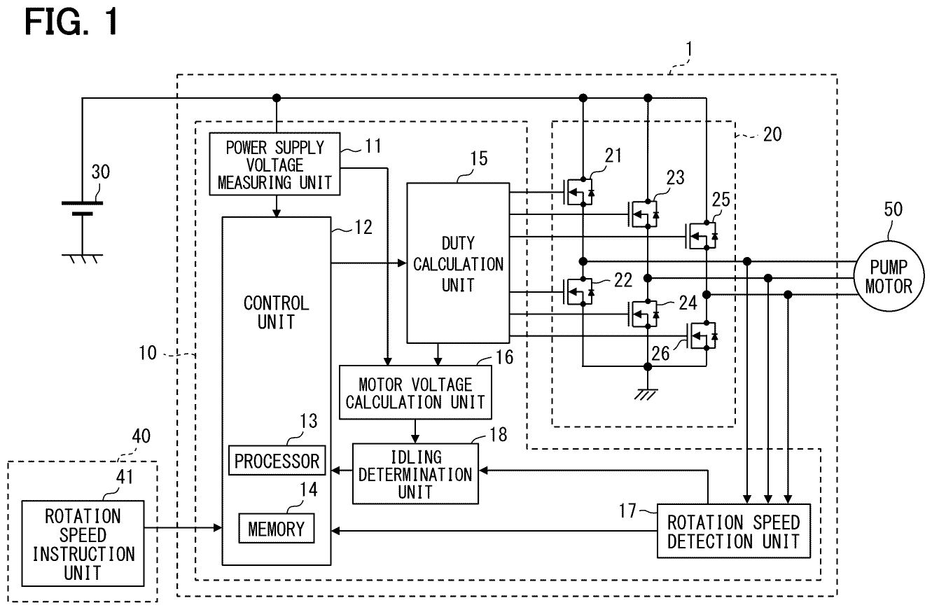

FIG. 1 is a block diagram showing an overall configuration of a motor control device 1 including a motor idling detection device according to a present embodiment. The motor control device 1 according to the present embodiment can be mounted on, for example, a vehicle and used to drive a motor 50 of a fuel pump that pumps up fuel stored in a fuel tank and supplies it to a fuel injection system. However, the application of the motor 50 that is drive-controlled by the motor control device 1 of the present embodiment is not limited to this particular use. For example, the motor 50 may drive an oil pump for circulating engine oil in a vehicle. In addition, the motor 50 may drive a washer pump that draws in and discharges windshield washer fluid. Furthermore, the motor 50 may be used to drive a pump that draws in and discharges liquid outside of a vehicle.

The motor 50 to be controlled by the motor control device 1 according to the present embodiment may be, for example, a three-phase brushless motor having a permanent magnet in a rotor and three-phase stator coils in a stator. However, the motor 50 to be controlled by the motor control device 1 according to the present embodiment is not limited to the three-phase brushless motor, but may be a brushed motor or an induction motor. Furthermore, the motor 50 may be a two-phase motor or a multi-phase motor having three or more phases.

As shown in FIG. 1, the motor control device 1 of the present embodiment includes a controller 10 and an inverter 20. The controller 10 includes a power supply voltage measuring unit 11, a control unit 12, a duty calculation unit 15, a motor voltage calculation unit 16, a rotation speed detection unit 17, and an idling determination unit 18. Each unit of the controller 10 can be configured by software, hardware, or a combination of software and hardware. For example, the motor voltage calculation unit 16 and the idling determination unit 18 may be realized by a program executed by a processor 13 included in the control unit 12. Alternatively, the motor voltage calculation unit 16 and the idling determination unit 18 may be realized by a program executed by at least one processor different from the processor 13 included in the control unit 12. Furthermore, at least a part of the functions of the motor voltage calculation unit 16 and the idling determination unit 18 may be realized by a hardware circuit.

The power supply voltage measuring unit 11 measures the power supply voltage supplied from a power supply 30 to the inverter 20. For example, the power supply voltage measuring unit 11 includes a resistor and an A/D converter. The A/D converter converts the power supply voltage applied to the resistor into a digital value and outputs it to the control unit 12 and the motor voltage calculation unit 16.

The control unit 12 has a processor 13 and a memory 14. The processor 13 of the control unit 12 executes various processes in accordance with the control programs stored in the memory 14, thereby carrying out motor control. For example, the control unit 12 receives the power supply voltage measured by the power supply voltage measuring unit 11. Then, the control unit 12 determines whether the received power supply voltage is within a predetermined normal voltage range. When the control unit 12 determines that the power supply voltage is within the predetermined normal voltage range, it executes the motor control. In other words, when the power supply voltage is at an abnormal value, the control unit 12 can stop the motor control.

The control unit 12 receives a target rotation speed of the motor 50 as a control target value from a rotation speed instruction unit 41 provided in the upper-level control device 40. Then, based on the received target rotation speed and the actual rotation speed of the motor 50 detected by the rotation speed detection unit 17 described later, the control unit 12 calculates command values corresponding to each phase of the motor 50 (U-phase command value, V-phase command value, W-phase command value) so that the actual rotation speed approaches the target rotation speed. The calculation of this command value is repeatedly executed, for example, every time the motor 50 advances by a predetermined angle. The calculated command value is output to the duty calculation unit 15.

The duty calculation unit 15 compares the command value output from the control unit 12 with a triangular wave signal, and generates a PWM signal for generating a pseudo AC current to be applied to the stator coils of each phase based on a comparison result between the command value and the triangular wave signal. At the same time, the duty calculation unit 15 calculates a duty ratio of the generated PWM signal. That is, the duty calculation unit 15 calculates the duty ratio of the PWM control. The duty calculation unit 15 outputs the calculated duty ratio to the motor voltage calculation unit 16.

Here, the command value is calculated, for example, to have a sine wave shape, and the frequency of the sine wave is determined so that it becomes higher (the period becomes shorter) as the target rotation number (target rotation speed) of the motor 50 becomes higher. However, the command value may be calculated to have a square wave shape. That is, either sine wave driving or square wave driving may be used. On the other hand, the triangular wave signal is generated, for example, by using an up-down counter that alternately counts up and down. This up-down counter may be configured by either a hardware or software type. The frequency and period of this triangular wave signal also change with the same tendency as the frequency and period of the command value, for example, the clock frequency that counts up and down is changed, or the value that counts up and down is changed at the same timing. This makes it possible to appropriately adjust the period of the generated PWM signal.

The PWM signals generated corresponding to each phase are output to the inverter 20. The inverter 20 has three pairs of bridge-connected switching elements 21 and 22, 23 and 24, and 25 and 26 corresponding to the U-phase, V-phase, and W-phase of the motor 50. The PWM signals are supplied to the gates of the switching elements 21 to 26, and each of the switching elements 21 to 26 is turned on and off in accordance with the corresponding PWM signal. As a result, a pseudo AC current corresponding to the command value is passed through the stator coil of each phase of the motor 50. At this time, among the three sets of switching elements 21 to 26, a predetermined combination of high potential side switching elements and low potential side switching elements are turned on simultaneously, and a pseudo AC current is passed through the stator coil of each phase so as to switch the combination of high potential side switching elements and low potential side switching elements to be turned on. As a result, a rotating magnetic field is generated in the three-phase stator coil, and the rotor rotates in accordance with the rotating magnetic field, thereby driving the motor 50 to rotate.

The motor voltage calculation unit 16 calculates the motor voltage to be applied to the motor 50 from the duty ratio calculated by the duty calculation unit 15 when performing PWM-control each of the switching elements 21 to 26 and the power supply voltage measured by the power supply voltage measuring unit 11. The power supply voltage becomes the input voltage of the inverter 20. The input voltage of the inverter 20 is applied to the motor 50 when the switching elements 21 to 26 are turned on. Therefore, by multiplying the input voltage of the inverter 20 by the duty ratio, which is the ratio at which the switching elements 21 to 26 are turned on, the motor voltage actually applied to the motor 50 can be calculated. The motor voltage calculation unit 16 outputs the calculated motor voltage to the idling determination unit 18. The motor voltage calculation unit 16 corresponds to an acquisition unit in the present disclosure.

The rotation speed detection unit 17 detects the rotation speed and rotation angle of the rotor (i.e., the motor 50) based on an induced voltage generated in the non-energized phase of each stator coil by the rotation of the rotor in the motor 50. In other words, the rotational position of the motor 50 (rotor) can be detected every time the motor 50 (rotor) rotates by 60 degrees based on the induced voltage of the non-energized phase. Then, the number of rotations per unit time (i.e., the rotation speed) of the motor 50 can be calculated from the time required for the motor 50 to rotate 60 degrees. The rotation speed detection unit 17 outputs the detected rotation speed and rotation angle of the motor 50 to the control unit 12 and the idling determination unit 18.

The rotation speed and rotation angle of the motor 50 may be detected using a position detection device that detects and outputs position information related to the rotation angle of the motor 50. As the position detection device, for example, a resolver sensor can be used. As is well known, the resolver sensor has coils provided on the rotor and stator of the motor 50, respectively. When the rotor rotates with an AC voltage applied to the coil on the rotor-side, the distance to the coil on the stator-side changes so that an AC voltage with a varying amplitude is generated in the coil on the stator-side. From this voltage change, the rotation speed and rotation angle of the motor 50 can be detected.

Alternatively, the position detection device may use three Hall elements that detect the current phases of U-phase, V-phase, and W-phase currents, which are pseudo AC currents (pseudo sine wave currents) applied to each phase of a three-phase stator coil. Each of these Hall elements detects a change in current in a specific stator coil as a change in magnetic flux. In a three-phase brushless motor, the phases of the U-phase current, V-phase current, and W-phase current, which are three-phase pseudo AC currents, are shifted by 120 degrees each. Therefore, by combining the detection signals of the three Hall elements, the rotational position of the motor 50 (rotor) can be detected every time the motor 50 rotates by 60 degrees. It is also possible to detect the rotational position of the rotor by detecting a change in magnetic flux of the rotor using at least one Hall element.

The idling determination unit 18 compares the motor voltage calculated by the motor voltage calculation unit 16 with a predetermined idling determination threshold value for determining whether the motor 50 is idling. The idling determination unit 18 then determines whether the motor 50 is idling or not based on the result of comparing the motor voltage with the idling determination threshold value. The idling determination unit 18 outputs the determination result as to whether or not the motor 50 is idling to the control unit 12. When the idling determination unit 18 determines that the motor 50 is idling, the control unit 12 executes a process for determining idling. In other words, the control unit 12 corresponds to an execution unit of the present disclosure. Moreover, the idling detection device of the present disclosure is mainly composed of the motor voltage calculation unit 16 and the idling determination unit 18. Furthermore, since the idling detection device of the present disclosure also utilizes the functions of the power supply voltage measuring unit 11, the duty calculation unit 15, and the rotation speed detection unit 17, these units can also be said to be components of the idling detection device.

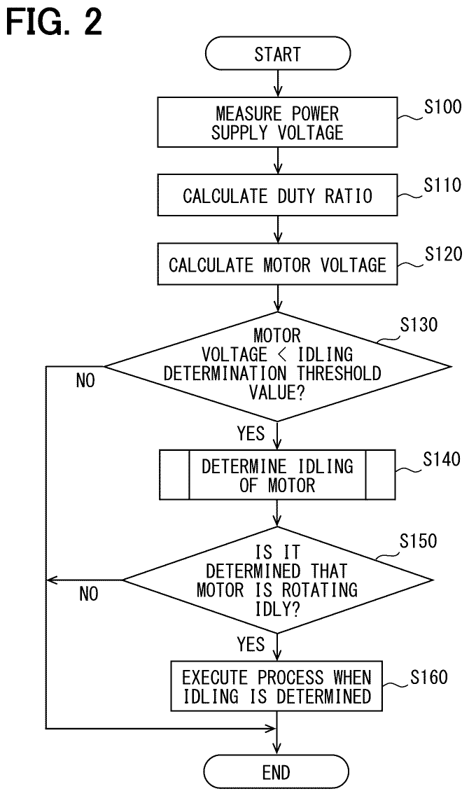

Next, the process for determining whether the motor 50 is idling and the procedure to be followed when the motor 50 is idling will be described in detail with reference to the flow chart of FIG. 2. The process shown in the flowchart of FIG. 2 can be executed in the idling detection device by at least one processor, including the processor 13, executing a program stored in a storage medium, including the memory 14. Execution of the process shown in the flowchart of FIG. 2 by the idling detection device corresponds to executing a method for detecting the idling. The process shown in the flowchart of FIG. 2 is periodically and repeatedly executed by the idling detection device.

In a first step S100, the idling detection device measures the power supply voltage supplied from the power supply 30 to the inverter 20. In the next step S110, the idling detection device calculates the duty ratio when each of the switching elements 21 to 26 constituting the inverter 20 is performed by the PWM-control. Then, in step S120, the idling detection device calculates the motor voltage to be applied to the motor 50 by multiplying the power supply voltage measured in step S100 by the duty ratio calculated in step S110.

In step S130, the idling detection device determines whether the calculated motor voltage is smaller than a predetermined idling determination threshold value. When it is determined that the calculated motor voltage is smaller than the predetermined idling determination threshold value, the idling detection device proceeds to the process of step S140. On the other hand, when it is determined that the calculated motor voltage is equal to or greater than the predetermined idling determination threshold value, it is determined that the motor 50 is not rotating idly, and the idling detection device ends the process shown in the flowchart of FIG. 2.

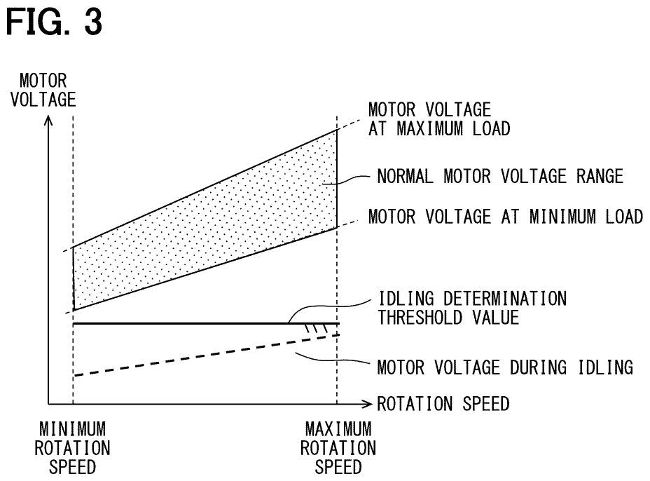

Here, when the motor 50 of the present embodiment drives, for example, a fuel pump that intakes and discharges the fuel stored in a fuel tank of a vehicle, if there is sufficient fuel remaining in the fuel tank, the rotation speed of the motor 50 increases, and the load on the motor 50 increases as the amount of fuel discharged increases. Therefore, as shown in FIG. 3, the higher the rotation speed of the motor 50, the higher the motor voltage becomes. Incidentally, even with the same rotation speed of motor 50, the load on the motor 50 fluctuates between maximum and minimum loads for the following reasons: The load is affected by the level of fuel pressure in the pipe to which the fuel is discharged; the properties of fuel differ depending on the country or region; and the viscosity of the fuel changes depending on the fuel temperature, etc. Therefore, when the motor voltage is within the range between the motor voltage at maximum load and the motor voltage at minimum load, which varies depending on the rotation speed of the motor 50 (i.e., the normal motor voltage range), the fuel pump driven by the motor 50 can be considered to be drawing in and discharging fuel normally.

On the other hand, when the motor voltage drops below the motor voltage at the minimum load, it can be considered that the load on the motor 50 has decreased due to air being contained in the fuel drawn in and discharged by the fuel pump. The higher the ratio of air contained in the fuel, the more the motor voltage drops below the motor voltage at the minimum load. When the fuel pump draws in and discharges almost only air, the motor voltage is close to the idling motor voltage shown by the dotted line in FIG. 3.

In the present embodiment, a certain idling determination threshold value is used as the predetermined idling determination threshold value, which is smaller than the motor voltage (its minimum value) at the minimum load and larger than the motor voltage (its maximum value) during idling. By setting the idling determination threshold value to a constant value that is smaller than the motor voltage at minimum load and larger than the motor voltage during idling, it is possible to determine that there is a high possibility that the motor 50 is idling (or rotating in a state close to idling) when the motor voltage falls below the idling determination threshold value, regardless of the rotation speed of the motor 50. In the present embodiment, a state close to idling is also considered as idling of the motor 50.

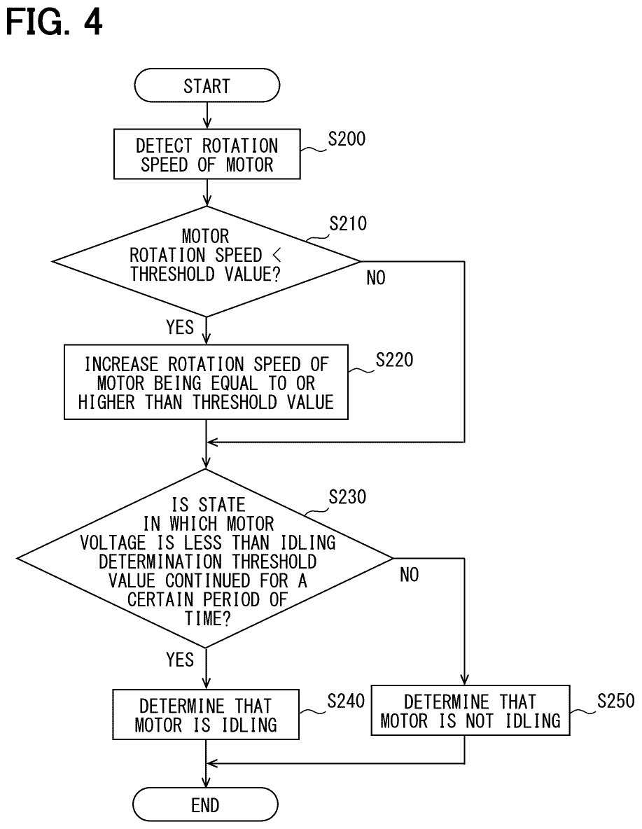

It is also possible to determine whether the motor 50 is idling by the determination process of step S130 described above, and to implement procedures taken when it is determined that the motor 50 is rotating in idling. However, in the present embodiment, in order to improve the accuracy of the idling determination, the idling detection device determines in more detail in step S140 whether the motor 50 is idling. Hereinafter, the process of determining whether the motor 50 is idling in step S140 will be described in detail with reference to the flowchart of FIG. 4.

In the first step S200, the idling detection device detects the rotation speed of the motor 50. In the next step S210, the idling detection device compares the detected rotation speed of the motor 50 with a threshold value for determining whether or not the motor 50 is rotating in the low rotation speed range. When it is determined that the rotation speed of the motor 50 is smaller than the threshold value, the idling detection device proceeds to the process of step S220. On the other hand, when it is determined that the rotation speed of the motor 50 is equal to or greater than the threshold value, the idling detection device proceeds to the process of step S230.

In step S220, the idling detection device instructs the control unit 12 to increase the rotation speed of the motor 50 so that the rotation speed of the motor 50 increases to a rotation speed equal to or higher than the threshold value. When the motor 50 is rotating in the low rotation speed range, as shown in the graph of FIG. 3, the interval between the normal motor voltage range and the idling determination threshold value becomes narrow. Therefore, even if the motor 50 is not rotating idly, it may be erroneously determined that the motor voltage is smaller than the idling determination threshold value. On the other hand, when the motor 50 rotates at a higher rotation speed than in the low rotation speed range, the interval between the normal motor voltage range and the idling determination threshold value becomes wider, as shown in the graph of FIG. 3. Therefore, when the motor 50 is rotating at a higher rotation speed than the low rotation speed range, the possibility of erroneously determining that the motor voltage is smaller than the idling determination threshold value can be reduced, compared to when the motor is rotating in the low rotation speed range. For this reason, in the present embodiment, when the motor 50 is rotating in a low rotation speed range below the threshold value, it is necessary that the rotation speed of the motor 50 is increased.

In step S230, the idling detection device determines whether or not the state in which the motor voltage is less than the idling determination threshold value has continued for a certain period of time. For example, assume that a pump driven by the motor 50 is mounted on a vehicle. The Vehicles not only travel on flat roads, but also on slopes and uneven road surfaces. In such driving conditions, it may occur that the liquid to be sucked by the pump becomes unevenly distributed in the tank, and cannot be sufficiently sucked by the pump. However, it is expected that the imbalance of the liquid in the tank is temporary, and the pump will soon be able to draw in the liquid. Therefore, in the present embodiment, it is determined whether or not the state in which the motor voltage is less than the idling determination threshold value continues for a certain period of time. Therefore, it is possible to determine with high accuracy that the idling of the motor 50 is not due to a temporary imbalance in the liquid in the tank, but is due to a small amount of liquid to be sucked, in other words, that the idling of the motor 50 will continue. When it is determined in step S230 that the state in which the motor voltage is less than the idling determination threshold value has continued for a certain period of time, the idling detection device proceeds to the process of step S240. On the other hand, when it is determined that the state in which the motor voltage is less than the idling determination threshold value has not continued for the certain period of time, the idling detection device proceeds to the process of step S250.

In step S240, the idling detection device determines that the motor 50 is idling. On the other hand, in step S250, the idling detection device determines that the motor 50 is not idling. Thereafter, the idling detection device ends the process shown in the flowchart of FIG. 4, and returns to the process shown in the flowchart of FIG. 2.

The process shown in the flowchart of FIG. 4 can improve the accuracy of determining whether or not the motor 50 is rotating idly. As a result, for example, when the motor 50 drives a fuel pump that draws up and discharges fuel stored in a vehicle's fuel tank, it is possible to prevent a malfunction such as insufficient fuel being supplied to the engine by stopping the motor 50 due to an erroneous determination that motor 50 is rotating idly.

In the flowchart of FIG. 4, in order to improve the accuracy of determining whether or not the motor 50 is rotating idly, when the rotation speed of the motor 50 is in the low rotation speed range, a process of increasing the rotation speed of the motor 50 and a process of determining whether or not the motor voltage has remained below the idling determination threshold value for a certain period of time are executed. However, even if only one of the above processes is executed, it is possible to improve the accuracy of determining whether or not the motor 50 is rotating idly. At this time, since the rotation speed of the motor 50 is in the low rotation speed range, when only the process of increasing the rotation speed of the motor 50 is executed, after the rotation speed of the motor 50 is increased, the motor voltage and the idling determination threshold value are compared again. When the motor voltage is smaller than the idling determination threshold value, it may be determined that the motor 50 is rotating idly.

In step S150 of the flow chart of FIG. 2, the idling detection device determines whether or not it has been determined in the idling determination process of the motor 50 in step S140 that the motor 50 is rotating idly. When it is determined in step S140 that the motor 50 is rotating idly, the rotation detection device proceeds to the process of step S160. On the other hand, when it is determined in step S140 that the motor 50 is not rotating idly, the rotation detection device ends the process shown in the flowchart of FIG. 2.

In step S160, the idling detection device notifies the control unit 12 that idling of the motor 50 has been detected. In response to this notification, the control unit 12 performs a process for determining that the idling has occurred. For example, as a measure to be taken when determining that the idling has occurred, the control unit 12 performs at least one of the following: storing in the memory 14 the fact that idling of the motor 50 has been detected, notifying the upper-level control device 40 which indicates the control target value of the motor 50, and stopping the rotation of the motor 50. By storing the detection of idling of the motor 50, it becomes possible to estimate, for example, the degree of influence on performance, such as the lifespan of the pump, from the stored result. Furthermore, by notifying the upper-level control device 40, the upper-level control device 40 can take appropriate measures, such as lowering the control target value. Furthermore, by stopping the rotation of the motor 50, problems caused by the idling of the motor 50 can be suppressed.

The above-mentioned measures to be taken when it is determined that the motor 50 is idling may be selected depending on a level of the probability that the motor 50 is idling. For example, when it is determined in step S130 that the motor voltage is smaller than the idling determination threshold value, the followings may be selectively used: (i) the result of the determination is stored in memory 14; (ii) when the number of determination results reaches a predetermined number, a notification is sent to the upper-level control device 40; and (iii) when it is determined in step S140 that the motor 50 is idling, the rotation of the motor 50 is stopped, etc.

As described above, according to the idling detection device of the present embodiment, the motor voltage applied to the motor 50 is acquired by being calculated based on the power supply voltage and the duty ratio of the PWM-control. The acquired motor voltage is compared with the idling determination threshold value for determining whether the motor 50 is idling. Then, depending on the result of the comparison, it is determined whether or not the motor 50 is rotating idly. Therefore, according to the idling detection device of the present embodiment, it is possible to detect the idling of the motor 50 without using a highly accurate current sensor. Furthermore, according to the motor control device 1 of the present embodiment, it is possible to take appropriate measures when the motor 50 starts to rotate idly.

### Second Embodiment

Next, a motor control device 1 including a motor idling detection device according to a second embodiment of the present disclosure will be described. The motor control device 1 according to the present embodiment is configured similarly to the motor control device 1 according to the first embodiment. Therefore, a description of the configuration will be omitted.

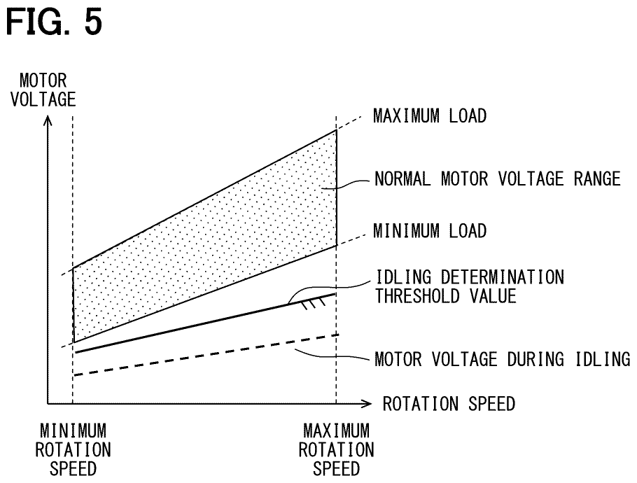

In the above-described first embodiment, the idling determination threshold value is set to a constant value that is smaller than the motor voltage at the time of minimum load and larger than the motor voltage when the motor is idling. In contrast, in the present embodiment, the idling determination value is set to change according to the rotation speed of the motor 50 so that when the rotation speed of the motor 50 is high, the idling determination value is larger than when the rotation speed of the motor 50 is low. For example, as shown in the graph of FIG. 5, the idling determination value is set so as to increase in proportion to an increase in the rotation speed of the motor 50 within a range smaller than the motor voltage at the time of minimum load and larger than the motor voltage during idling. As a result, it is possible to determine that the motor 50 is close to being in an idling state, regardless of the rotation speed of the motor 50, based on the result of comparing the motor voltage with the idling determination threshold value. The graph in FIG. 5 shows an example in which the idling determination threshold value increases linearly as the rotation speed of the motor 50 increases. However, the idling determination threshold value may be increased stepwise as the rotation speed of the motor 50 increases, for example.

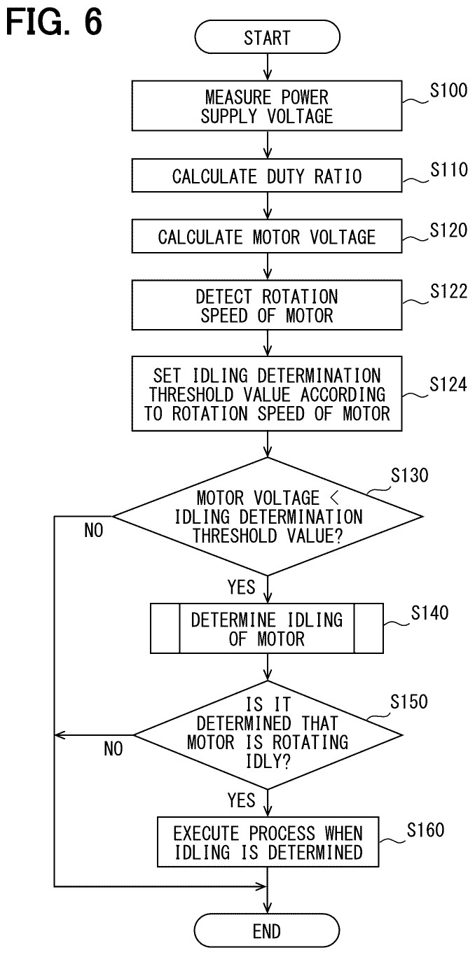

FIG. 6 is a flow chart showing the process for determining whether the motor 50 is idling and the procedure to be followed when the motor 50 is idling, in the present embodiment. The steps in which the same processes as those in the flowchart of FIG. 2 are performed are given the same step numbers, and the explanation thereof will be omitted.

In the flowchart of FIG. 6, steps S122 and S124 are added to the flowchart of FIG. 2. In step S122, the idling detection device detects the rotation speed of the motor 50. In the next step S124, the idling detection device sets an idling determination threshold value according to the detected rotation speed of the motor 50, for example, by referring to a map that stores the relationship between the rotation speed of the motor 50 and the idling determination threshold value. This makes it possible to set the idling determination value so as to change according to the rotation speed of the motor 50, so that when the rotation speed of the motor 50 is high, the idling determination value is larger than when the rotation speed of the motor 50 is low. Then, in step S130, the idling detection device compares the motor voltage calculated in step S120 with the idling determination threshold value set in step S124.

Although the preferred embodiments of the present disclosure have been explained above, the present disclosure is not limited to the above-described embodiments, and can be implemented by various modifications without departing from the spirit of the present disclosure.

According to each of the above-described embodiments, the motor voltage applied to the motor 50 is acquired by being calculated based on the power supply voltage and the duty ratio of the PWM-control. However, the motor voltage can also be obtained by measuring the voltage of each stator coil of the motor 50 and calculating from the measured voltages.

The present disclosure discloses multiple technical ideas listed below and multiple combinations thereof. The combination of the following technical features applies not only to the motor idling detection device but also to the method for detecting the motor idling and the tangible computer readable medium storing a program.

The control units and methods thereof described in the present disclosure may be implemented by a dedicated computer including a processor programmed to execute one or more functions embodied by a computer program and a memory. Alternatively, the control units and the methods thereof described in the present disclosure may be implemented by a dedicated computer including a processor with one or more dedicated hardware logic circuits. Alternatively, the control circuit and method described in the present disclosure may be realized by one or more dedicated computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium.

What is claimed is:

1. A motor idling detection device for detecting idling of a motor that drives a pump that draws in and discharges liquid, comprising:
an acquisition unit configured to acquire a motor voltage applied to the motor; and
an idling determination unit configured to compare the motor voltage acquired by the acquisition unit with an idling determination threshold value for determining whether the motor is idling, and determine whether the motor is idling or not based on a result of a comparison.

2. The motor idling detection device according to claim 1, wherein
the motor is rotationally driven by PWM-control of switching elements constituting an inverter, and
the acquisition unit calculates a motor voltage from a duty ratio of the PWM-control and a power supply voltage applied to the inverter.

3. The motor idling detection device according to claim 1, wherein
the idling determination threshold value changes in accordance with the rotation speed of the motor so as to be larger when the rotation speed of the motor is high than when the rotation speed is low.

4. The motor idling detection device according to claim 1, wherein
the idling determination unit increases a rotation speed of the motor based on the motor voltage being lower than an idling determination threshold value, and determines that the motor is idling when the motor voltage after the rotation speed has increased is lower than the idling determination threshold value.

5. The motor idling detection device according to claim 4, wherein
the idling determination unit increases the rotation speed of the motor in order to determine whether the motor is idling when the rotation speed of the motor is less than a predetermined rotation speed threshold value.

6. The motor idling detection device according to claim 1, wherein
the idling determination unit determines that the motor is idling when the motor voltage remains lower than the idling determination threshold value for a certain period of time.

7. The motor idling detection device according to claim 1, wherein
the pump is a fuel pump that draws in fuel from a fuel tank of a vehicle and delivers the drawn fuel to an engine of the vehicle.

8. A motor control device, comprising:
a motor idling detection device according to claim 1; and
an execution unit that, in response to detecting idling of the motor by the motor idling detection device, executes at least one of the following: storing a detection of idling of the motor, notifying an upper-level control device that indicates a control target value of the motor, and stopping a rotation of the motor.

9. A method for detecting idling of a motor that drives a pump that draws in and discharges liquid, the method being executed by at least one processor, comprising:
obtaining a motor voltage applied to the motor; and
comparing the motor voltage obtained with an idling determination threshold value for determining whether the motor is idling, and determining whether the motor is idling or not based on a result of a comparison.

10. A tangible computer readable medium storing a program for causing at least one processor to detect idling of a motor that drives a pump that draws in and discharges liquid, wherein
the program includes instructions configured to, when executed by at least one processor, to cause the at least one processor to function as
obtaining a motor voltage applied to the motor, and
comparing the motor voltage obtained with an idling determination threshold value for determining whether the motor is idling, and determining whether the motor is idling or not based on a result of a comparison.
